(19) United States
(12) Patent Application Publication
(10) Pub. No.: US 2010/0330365 A1
(43) Pub. Date: Dec. 30, 2010

(54) STRAND-LIKE MATERIAL COMPOSITE WITH CNT YARNS AND METHOD FOR THE MANUFACTURE THEREOF

(76) Inventors: Jörg Hassel, Erlangen (DE); Hans-Richard Kretschmer, Berlin (DE); Daniel Reznik, Berlin (DE); Arno Steckenborn, Berlin (DE)

Correspondence Address: STAAS & HALSEY LLP, SUITE 700, 1201 NEW YORK AVENUE, N.W., WASHINGTON, DC, 20005, US

(21) Appl. No.: 12/736,068

(22) PCT Filed: Feb. 24, 2009
(86) PCT No.: PCT/EP2009/052173

§ 371 Date: Sep. 7, 2010

(30) Foreign Application Priority Data
Mar. 7, 2008 (DE) 10 2008 013 518.6

(51) Int. Cl. B32B 9/00; B05D 3/00; C25D 3/00

(52) U.S. Cl. 428/367; 427/294; 205/261; 977/742

(57) ABSTRACT

A strand-like material is formed of CNT yarns that are embedded in a metal matrix. The embedding in a common matrix has the advantage in that the material composite exhibits an improved electrical conductivity. This lies in the ability for electrons to switch from the CNT to the matrix and back again. The strand-like material composite is therefore suitable for use as an electrical conductor. Further proposed is a method for producing the strand-like material composite.

### CROSS REFERENCE TO RELATED APPLICATIONS

This application is based on and hereby claims priority to International Application No. PCT/EP2009/052173 filed on Feb. 24, 2009 and German Application No. 10 2008 013 518.6 filed on Mar. 7, 2010, the contents of which are hereby incorporated by reference.

### BACKGROUND

The invention relates to a strand-like material composite formed of CNT yarns which are enveloped by a metallic component.

A strand-like material composite of the type mentioned in the introduction is known from WO 2007/015710 A2. This strand-like material composite is obtained as a CNT yarn by virtue of the fact that firstly carbon nanotubes (referred to for short as CNTs in conjunction with this application) of a specific length are produced on a suitable substrate, the carbon nanotubes being connected at one end to the substrate and protruding away from the substrate at the opposite end, such that a forest-like structure is produced. According to WO 2007/015710 A2, it is then possible to obtain the CNT yarn by breaking off CNTs from the substrate at the edge of the latter and pulling them away therefrom. This results in a self-organizing process, where CNTs adjacent in each case to the CNTs breaking off on the substrate are carried along, these staying together in each case at the ends. This makes it possible to produce yarns having CNT fibers which are much longer than the individual CNTs located on the substrate.

According to WO 2007/015710 A2, it is also known that the yarns produced in the manner described are subjected to a subsequent coating treatment. By way of example, the yarns obtained are coated electrochemically. In this context, a relatively thin layer of a metal found in the electrolyte is deposited on the yarns.

It is known from “Spinning and Processing Continuous Yarns from 4-Inch Wafer Scale Super-Aligned Carbon Nanotubes Arrays” by Xiaobo Zhang, Adv. Mater. 2006, 18, 1505-1510 that CNT yarns are electrically conductive owing to the properties of CNTs. This makes it possible to heat the CNT yarns to up to 2000 K with conduction of an electric current. On the other hand, it is known from U.S. 2007/0036978 A1 that CNTs in an electrochemically deposited metal layer can improve the conductivity. Here, the CNTs are randomly incorporated in the electrochemically produced layer, if they are dispersed in the electrolyte. The maximum achievable CNT incorporation rates are subject to limits in this respect for process reasons.

### SUMMARY

One possible object is therefore to specify a strand-like material composite with CNT yarns and a metallic component, which has the highest possible electrical conductivity with respect to the CNT content of the material composite.

The inventors propose a strand-like material composite of the type mentioned in the introduction by virtue of the fact that the metallic component is in the form of a matrix which spans the cross section of the composite. This means that the CNT yarns pass through the strand-like material composite in the direction of the strand and the hollow spaces located between the yarns are at least partially filled with the metallic component. Here, the metallic component in each case electrically connects the adjacent CNT yarns, and in this context a single metallic matrix is available. Compared to CNT yarns according to WO 2007/015710 A2, in this case there is improved electrical conductivity. Specifically, the CNT yarns according to the related art are respectively enveloped metallically per se. If these are joined together to form strands of larger diameter, although these metallic envelopes come to bear one against another, the contact surfaces between the metallic envelopes are relatively small. Investigations have shown that the electrical resistance of a CNT yarn with individual envelopes can be influenced decisively by a reduction in the resistance in the metallic component. In the metallic transitions of the strand-like material composite according to WO 2007/015710 A2, it is possible to see the bottleneck with respect to the reduction in the electrical resistance. This can be explained by stating that the CNTs present in the yarns do not reach their theoretically possible conductivity since, instead of being present as endless fibers, they are formed from relatively short fiber sections. Between these fiber sections, the electric current has to be conducted conventionally through the metallic component, which has a significantly higher resistance than the CNTs. A great potential to reduce the electrical resistance of the entire material composite therefore relates to reducing the resistance of the metallic component as far as possible. This can be achieved by forming the metallic component of the composite in a matrix which spans the cross section of the composite, since this measure means that there is a greater cross-sectional area available between the adjacent CNT yarns. This also makes it possible for current to flow between adjacent CNT yarns. As a result of this, it is possible to achieve the greatest possible increase in electrical conductivity with identical use of CNT material as a result of suitable configuration of the composite conductor (metallic matrix). This advantageously makes it possible to produce a low-cost composite conductor with outstanding electrical properties.

Within the context of this document, “CNTs” are to be understood in a broader sense as meaning all forms of carbon nanotubes. These include both Single Wall Carbon Nanotubes (SWNTs) and Multi Wall Carbon Nanotubes (MWNT), which have a multi-shell design.

The matrix of the metallic component should be understood as meaning a metallic microstructure which represents a uniform material composite. However, this composite may be forms of a plurality of grains, where the matrix is to be considered as uniform over the entire cross section owing to the cohesion of the metallic microstructure at the grain boundaries. Specifically, the influence of the grain boundaries on the electrical conductivity of the matrix is negligible since the migration of the electrons, which bring about a flow of current, is scarcely impeded by the grain boundaries.

Within the context of the this document, CNT yarns are to be understood as meaning CNT strands which are formed of at least one CNT fiber. In the latter, the individual CNTs bond to one another in each case at their ends, and so the CNT fiber can have many times the length of the individual CNTs. It is also possible for a plurality of CNT fibers to be joined together to form a CNT yarn. In this case, there may also be contact between the individual CNT fibers of a yarn. In particular, a CNT yarn according to U.S. 2007/0036978 A1 can also be used to produce the strand-like material composite, where the formation of a metallic component with a matrix which spans the cross section of the composite is ensured by joining this yarn together with further yarns of this type and subsequently treating it suitably in order to produce the metallic matrix. This subsequent treatment can be, for example, an electrochemical coating of the composite of CNT yarns (more details in this respect below).

According to one advantageous refinement, it is provided that the CNT yarns in the matrix are oriented substantially in the direction of the strand-like profile thereof. This firstly has advantages for the production, since the CNT yarns can be guided in the direction of the strand-like material composite which is being produced. Secondly, the orientation of the CNT yarns parallel with the strands also improves the electrical conductivity of the strand-like material composite produced, since the paths of improved electrical conductivity formed by the CNTs are oriented substantially along the flow of current to be expected.

Another refinement provides that the proportion of CNT yarns in the matrix is in a range of 2 to 20% by volume, preferably 4 to 10% by volume. To be precise, within this range it is advantageously possible to obtain a relatively high gain in conductivity in the composite conductor with relatively limited use of the relatively expensive raw material of the CNTs. In addition, it must be taken into consideration for the configuration of the material composite that the addition of the CNTs to the metallic matrix makes it possible to rule out a negative influence on the mechanical properties or to at least keep this influence within an acceptable limit. In the case of a matrix of metallic material which spans the composite, a material composite having at most 20% by volume of CNT yarns will substantially still have the behavior of a metallic material. This means that stresses, which arise in particular owing to the significantly higher rigidity of CNTs compared to metallic materials, can still be compensated for by the metallic microstructure. Stresses which can be compensated for by the metallic matrix by the described mechanism also arise in terms of the different coefficients of thermal expansion of CNTs and metallic materials. This also represents the significant difference from the strand-like material composite according to WO 2007/015710 A2, in which the properties are determined primarily by the CNTs present in the composite. In the case of this strand-like material composite, the metallic component specifically has a significantly smaller volumetric proportion in the composite, and so this can adapt to the mechanical properties of the CNTs, which determine the mechanical properties of the overall composite. However, the low volumetric proportion of metallic material also limits the improvement in the electrical conductivity of the material composite formed according to WO 2007/015710 A2, which is therefore available for electrical applications only to a limited extent.

A special refinement is obtained if the CNT yarns in the matrix comprise in each case only 1 to 10 fibers. In this context, it is taken into consideration that an exchange of electrons between adjacent CNTs is promoted by the metallic matrix only when the latter is also present between the CNTs. On the other hand, the processing of CNT yarns with only one fiber entails an increased production outlay, and this makes the product more expensive. This variant will therefore primarily play a role in applications where priority is given to optimizing the electrical properties over the resulting costs (for example in the air and space travel industry, which gains above-average benefits from a reduction in weight). On the other hand, in the case of multi-fiber yarns having up to 10 fibers, it is also possible for the yarn to contain only or at least primarily fibers which form part of the outer circumference of the yarn in question. Electron exchange with fibers of an adjacent yarn is thereby ensured via the intermediate metallic matrix.

The inventors also propose a process for producing a strand-like material composite, in which process firstly CNT yarns are produced or provided, and then these are enveloped with a metallic component. This process is described in WO 2007/015710 A2, which has already been mentioned in the introduction. The variant according to this document includes both the production of the CNT yarns and the subsequent coating thereof with a metallic material. It goes without saying that it is also possible to acquire the uncoated yarns from a specialist manufacturer and then to coat them. As already mentioned, the yarns coated in the processes described in the related art have a very high volumetric proportion of CNTs. The electrical conductivity of the strand-like material composites thus produced is limited.

It is therefore a further potential object to provide a process for producing a strand-like material composite containing CNT yarns, with which process it is possible to obtain a relatively high electrical conductivity.

This object may be achieved by the above-mentioned process by virtue of the fact that, in a subsequent production step or repeatedly in a plurality of subsequent production steps, a plurality of the CNT yarns provided with the metallic component are joined together, and the CNT yarn of larger diameter thus obtained is again enveloped with a metallic component, as a result of which a metallic matrix which spans the yarn of larger diameter is formed. If appropriate, the production steps described are repeated until the joining together of the yarns or of the yarns of larger diameter produces the required cross-sectional area of the strand-like material composite.

In order to achieve the desired, greatest possible increase in the conductivity of the strand-like material composite, it is essential that the fibers are present in the metallic matrix in the smallest possible amalgamations, preferably of less than 10 fibers. Firstly, this makes it possible to obtain a relatively small proportion of CNT yarns in the material composite of 2 to 20% by volume, preferably of 4 to 10% by volume. The mechanical properties of the strand-like material composite can thereby be set in such a way as to largely correspond to those of metallic microstructures. However, the measure of embedding the thinnest possible CNT yarns (i.e. yarns comprising few, preferably less than 10, individual fibers) produces the effect that exchange of the electrons between different fibers of the CNT yarns is made significantly easier by the metallic matrix situated between the latter. This effect is important for achieving the greatest possible increase in the electrical conductivity. This makes it possible to obtain a relatively large increase in conductivity with relatively minor outlay on CNT material (cf. also that stated in relation to the material composite).

An advantageous refinement of the process is obtained if the CNT yarns and/or the CNT yarns of larger diameter are enveloped with the metallic component by a vacuum coating process. The use of a vacuum coating process, e.g. CVD or PVD, has the advantage that these coatings can be applied directly to the CNTs. In addition, a range of metals and alloys thereof can be deposited, and so a virtually unrestricted range of materials is available for coating.

According to another refinement, it can be provided that the CNT yarns and/or the CNT yarns of larger diameter are enveloped with the metallic component by an electrochemical coating process. Electrochemical coating processes have the significant advantage over vacuum coating processes that more material can be applied at low cost. It is particularly advantageous if the CNT yarns and/or the CNT yarns of larger diameter are coated electrolytically with the metallic component, wherein the CNT yarns and/or the CNT yarns of larger diameter are connected as cathode. In this case, it is generally necessary, as compared with electrochemical coating, to apply an electrical potential to assist the coating operation (in general, electrochemical coating can also take place with zero current). The application of a potential advantageously makes it possible to increase the deposition rate for the metallic matrix. In addition, it is possible to deposit a relatively large range of metallic materials, because the deposition potential can be influenced by varying the applied voltage.

It is of course also possible, particularly in multi-stage processes, to combine the above-mentioned coating processes with one another. By way of example, a vacuum coating process can be used to apply a start layer to the CNT yarns, which simplifies a subsequent electrochemical, in particular electrolytic, coating.

It is particularly advantageous if the process proceeds continuously, wherein the number of CNT yarns which the strand-like material composite to be produced should contain are produced or provided simultaneously. All CNT yarns can therefore be treated simultaneously and are joined together in stages in the following production steps to form the desired strand-like material composite. In addition, the CNT yarns, which, as the process sequence continues, are in each case guided in parallel in a subsequent production step or in a plurality of subsequent production steps, are together enveloped with the metallic component and are joined together to form the yarns of larger diameter, also do not have to be kept in stock, since they are produced in a continuous process and are processed immediately to form the desired end product.

Furthermore, it is advantageous if the CNT yarns and/or the CNT yarns of larger diameter are joined together by stranding. In this case, the CNT fibers of the resulting material composite are each given a helical form by rotation about the center axis of the strand, and this leads to improved cohesion, in particular during the production process.

A special embodiment of the process is obtained by setting the volumetric proportion of CNT yarns in the metallic matrix by varying the duration of the production steps for enveloping the CNT yarns and the CNT yarns of larger diameter with the matrix material. The duration of the process for coating with the metallic matrix is decisive for the layer thickness on the CNT yarns and/or the CNT yarns of larger diameter. As a result of this, the volumetric proportion of the metallic matrix can be increased or reduced. It is important, however, that the treatment duration in the individual production steps suffices to bring about adequate application of material, so that a uniform matrix is established between the CNT yarns and/or CNT yarns of larger diameter respectively joined together. In this context, it is not necessary for the matrix material to completely fill the interspaces between the individual CNT yarns and/or CNT yarns of larger diameter. It is merely necessary for the material application to lead to sufficiently large material bridges between the yarns.

In the text which follows, the intention is to mathematically determine, by way of example, the volumetric proportion of CNT yarns required for a desired increase or reduction in the conductivity of the electrical resistance for the matrix material Cu. The calculation shown can of course be carried out in the same way for other matrix materials.

Consider a Cu cuboid having a square base area of the dimension I₁ and the length I_{cnt}. It is assumed by way of a model that a straight SWNT fiber having a diameter of d_{cnt} and a resistance of R_{cnt} is embedded in the center. By way of example, I₁ should be determined such that the electrical resistance of this unit cell is halved compared to pure copper. In this respect, the following mathematical approach is pursued.

The resistance of the Cu cuboid without a CNT is:

$${R}_{cu} = \frac{{ρ}_{cu} \cdot {l}_{cnt}}{{l}_{1}^{2}}$$

The resistance of the cuboid with an embedded CNT arises as a parallel connection of two resistances, specifically that of the CNT and that of the remaining Cu cuboid (from which the cross-sectional area of the CNT fiber is deducted):

$$\frac{1}{{R}_{cu / CNT}} = \frac{1}{{R}_{cnt}} + \frac{{l}_{1}^{2} - \frac{π}{4} {d}_{cnt}^{2}}{{ρ}_{cu} \cdot {l}_{cnt}}$$

The following equation arises if the ratio is formed:

$$\frac{{R}_{cu}}{{R}_{cu / CNT}} = 1 + \frac{{ρ}_{cu} \cdot {l}_{cnt}}{{R}_{cnt} \cdot {l}_{1}^{2}} - \frac{π}{4} {( \frac{{d}_{cnt}}{{l}_{1}} )}^{2}$$

Where
p_{cu}=1.7 μΩcm, l_{cnt}=10 μm, d_{cnt}=1 nm, R_{cnt}=10 kΩ

a resistance ratio of 2 is produced if l₁=4 nm.

A cuboid of this type has the CNT volume

$${l}_{cnt} \cdot \frac{π}{4} {d}_{cnt}^{2}$$

and the remaining copper has the volume

$${l}_{cnt} ( {l}_{1}^{2} - \frac{π}{4} {d}_{cnt}^{2} )$$

The volume ratio is

$$\frac{1}{\frac{4}{π} \frac{{l}_{1}^{2}}{{d}_{cnt}^{2}} - 1}$$

and is about 5%.

Expressed in % by weight,

5%·1.34/8.92=0.75%.

This states the preferred target value for the proportion of directional CNTs in the copper matrix of 0.5 to 1% by weight, compared to the proportions of CNTs with statistical orientation achievable according to the related art in electrochemically deposited layers of 1.5 to 3% by weight.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary embodiment of a proposed process for forming a strand-like composite as a plan view of a production plant shown partially in section, and

FIGS. 2 to 7 show various exemplary embodiments of the proposed strand-like material composite according to the invention, each as a cross-sectional view, where the exemplary embodiments shown at the same time show various production stages in the process according to FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

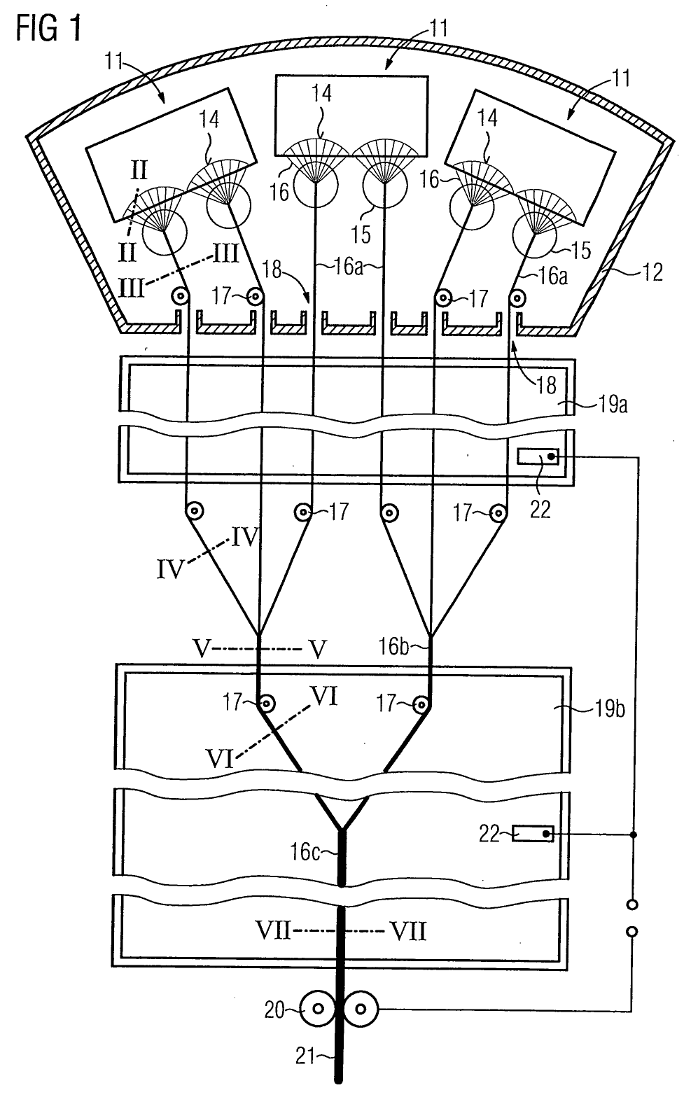

A production plant according to FIG. 1 can be used to carry out the process proposed by the inventors according to the invention. The FIG. 1 figure firstly shows three substrates 11, which are arranged in a vacuum chamber 12. These substrates are provided with grown CNTs on the front side shown. According to the process described in the introduction, elementary CNT yarns 16 are pulled away from this CNT layer in the form of a forest, in which case a front 14, at which the CNT fiber being removed is fed with new CNTs, is produced on the substrates 11.

The CNT yarns 16 span a plurality of sputter targets 15, where copper is vapor-deposited onto them. These yarns are then joined together to form a multi-fiber CNT yarn of larger diameter 16a. These CNT yarns of larger diameter 16a are deflected via rollers 17 and are guided in parallel out of the vacuum chamber 12 through locks 18 (not shown in more detail).

A first electrochemical bath 19a is arranged outside the vacuum chamber 12, and the CNT yarns of larger diameter 16a are guided into the bath via deflection rollers (not shown).

Here, the CNT yarns of larger diameter 16a are subjected to further coating with copper, where the amount of copper applied can be controlled by the deposition parameters in the electrochemical bath and also the dimensions (double break line in FIG. 1) thereof.

After the electrochemical coating, the CNT yarns of larger diameter 16a are guided out of the electrochemical bath 19a and joined together by further rollers 17 to form two strands, which form CNT yarns of larger diameter 16b. These CNT yarns of larger diameter 16a are fed into a further electrochemical bath 19b, where they are subjected to further electrochemical coating with copper, such that the interspaces between the CNT yarns of larger diameter 16b are filled and a metallic matrix which respectively spans the two strands is thereby formed, in which the CNT yarns of larger diameter 16b extend. In addition, rollers 17 are arranged within the further electrochemical bath 19b, and these make it possible to join the CNT yarns of larger diameter 16b together within the electrochemical bath 19b. This produces a further CNT yarn of larger diameter 16c, which for its part is guided a bit further through the electrochemical bath 19b so as to undergo further coating with copper. As a result of this, the mechanism already described is repeated, and so accordingly the interspaces between the two yarns of larger diameter 16b are at least largely filled and a metallic matrix which spans the CNT yarn of larger diameter 16c is thereby formed.

The CNT yarn of larger diameter 16c is the end product in the exemplary embodiment according to FIG. 1 and thus forms the strand-like material composite 21. In a manner which is not shown, this can also be provided, by way of example, with electrical insulation. It is also conceivable to join the CNT yarn of larger diameter 16c to further CNT yarns, in which case the diameter of the strand-like material composite to be produced increases further. It is also conceivable to produce the strand-like material composite 21 by using more substrates than those shown simultaneously with a greater thickness.

In order to make it possible to carry out electrolytic coating at the desired deposition rate, the CNT yarns of larger diameter 16a, 16b, 16c have to be connected as cathode, at which the copper is deposited. For this purpose, provision is made of a roller-shaped electrode 20, through which the strand-like material composite 21 is guided. The copper coating means that the CNT yarn of larger diameter 16a is already sufficiently electrically conductive in the first electrochemical bath 19a to transfer the current from the roller-shaped electrode 20. It goes without saying that anodes 22 also have to be provided in the electrochemical baths 19a, 19b, in order to make electrolytic coating with copper possible (electrical contact connection is indicated in FIG. 1).

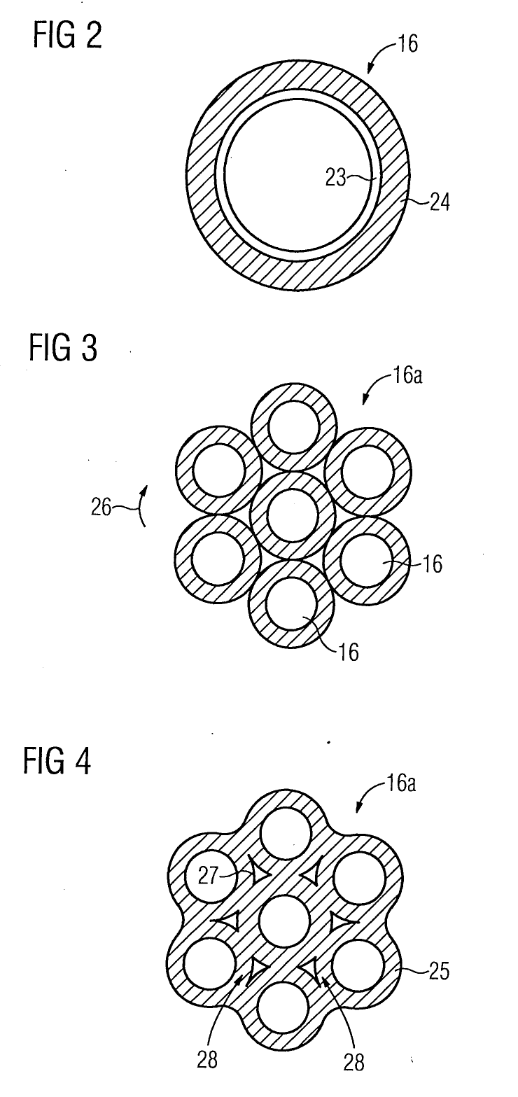

FIGS. 2 to 7 show different stages in the production of the strand-like material composite 21, these stages being indicated in FIG. 1 by the sections II-II to VII-VII. It will become clear how CNT yarns 16a, 16b ( 16c not shown) which become thicker and thicker in each case are produced from the CNT yarns 16 by repeated coating and joining together, and how the strand-like material composite 25 is produced by a final coating step with a copper matrix 25 completely spanning it and CNTs 23 extending therein. The individual copper layers can no longer be seen in the strand-like material composite 21 (cf. FIG. 7), since they have grown together to form a single matrix 25 as a result of the repetition of the electrochemical coating steps. However, the stepwise formation of the matrix 25 by the intervening electrochemical coating steps can readily be seen by comparing FIGS. 3 and 4 and FIGS. 5 and 6.

The elementary CNT yarn 16 according to FIG. 2 includes a strand of CNTs 23, it also being possible to see a sputtered layer 24 of copper. According to FIG. 3, seven of these elementary CNT yarns are joined together to form a yarn 16a of larger diameter, in which case stranding can take place as a result of rotation 26 of the resultant CNT yarn of larger diameter 16a, as shown, i.e. the elementary CNT yarns 16 are twisted together and extend helically. However, the subsequent further coating with copper, which takes place in FIG. 4 and allows the matrix 25 to be produced, means that stranding is not absolutely necessary, because cohesion of the CNT yarns 16 is ensured by the common matrix. It can also be seen in FIG. 4 that hollow spaces 27 which are not filled with copper may possibly remain in the matrix 25 during the subsequent electrochemical coating. This phenomenon can be accepted, however, because bridges 28 are produced through the matrix 25 between the adjacent elementary yarns 16 (cf. FIG. 3) despite these hollow spaces. The described phenomenon can of course also arise during subsequent copper coating steps as the production sequence continues, even if this is not shown in the subsequent figures.

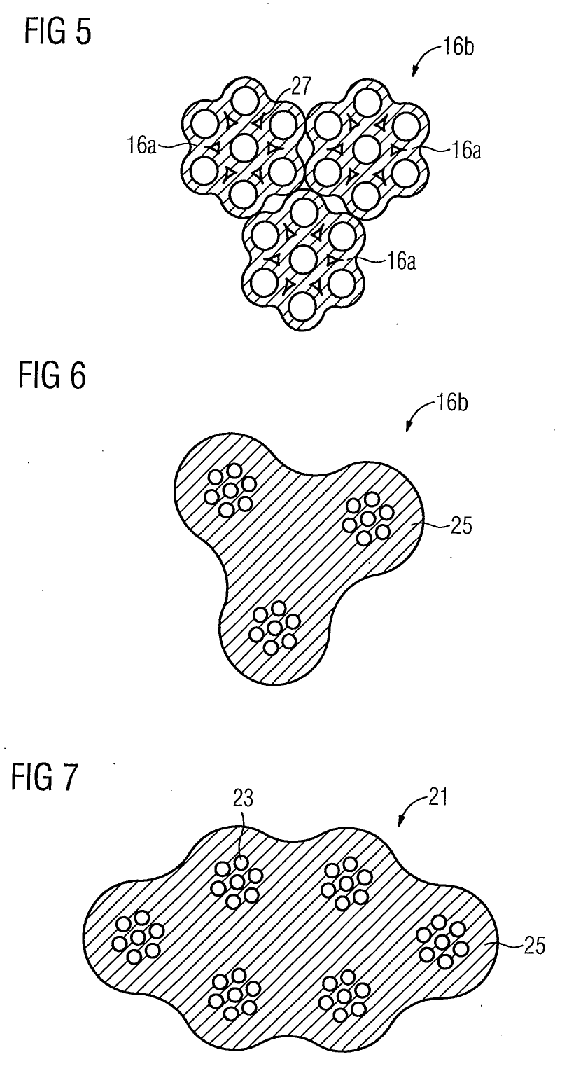

FIG. 5 shows how three of the yarns of larger diameter 16a according to FIG. 4 are joined together and, in a further electrochemical coating step according to FIG. 6, are joined together in such a manner that the uniform matrix 25 is formed. The figures do not show a next step of joining two CNT yarns of larger diameter 16b together to form a further CNT yarn of larger diameter 16c, as described in FIG. 1. After this assembly has been coated, the strand-like material composite 21 is produced, as shown in FIG. 7.

In a manner not shown, the coating step by sputtering according to FIG. 1 can also take place after a first joining together of the CNT yarns 16. For this purpose, the sputter targets 15 would merely have to be shifted to a location downstream from where the yarns are joined together. In this case, the yarns 16 according to FIG. 2 would only include the CNTs 23 and, in the case of the CNT yarn of larger diameter 16a according to FIG. 3, the CNTs would thus come to lie directly one on another (the elementary CNT yarn which undergoes the first coating with the matrix material would include the yarns 16 which formed the fibers of the elementary CNT yarn). In the subsequent step according to FIG. 4, in which electrochemical coating leads to the formation of the matrix 25 (possibly after a first coating by sputtering), the formation of bridges 28 between adjacent CNTs is then nevertheless made possible.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A strand-like material composite comprising:
carbon nanotubes (CNT) yarns;
a metallic component enveloping the CNT yarns to form the material composite, the material composite having a cross section, the metallic component being in the form of a matrix which spans the cross section of the material composite, wherein
the CNT yarns occupy 4 to 10% by volume of the material composite.

13. The material composite as claimed in claim 12, wherein
the material composite has a strand-like profile and extends in a length direction, and
the CNT yarns in the matrix are oriented substantially in the length direction of the strand-like profile.

14. The material composite as claimed in claim 12, wherein
the material composite is formed from a plurality of CNT yarns, and
each CNT yarn in the matrix is formed from only 1 to 10 fibers.

15. The material composite as claimed in claim 13, wherein
the material composite is formed from a plurality of CNT yarns, and
each CNT yarn in the matrix is formed from only 1 to 10 fibers.

16. A process for producing a strand-like material composite, comprising:
providing carbon nanotube (CNT) yarns; and
enveloping each CNT yarn with a metallic component;
joining together a plurality of the CNT yarns enveloped with the metallic component to form a larger diameter yarn;
enveloping the larger diameter yarn with the metallic component to form a metallic matrix which spans the larger diameter yarn; and
continuing to join together yarns of larger diameter and enveloping the yarns of larger diameter until a required cross-sectional area of the strand-like material composite is achieved.

17. The process as claimed in claim 16, wherein
the CNT yarns and/or the larger diameter yarn are enveloped with the metallic component using a vacuum coating process.

18. The process as claimed in claim 16, wherein
the CNT yarns and/or the larger diameter yarn are enveloped with the metallic component using an electrochemical coating process.

19. The process as claimed in claim 18, wherein
the CNT yarns and/or the larger diameter yarn are coated electrolytically with the metallic component, and
the CNT yarns and/or the larger diameter yarn are connected as a cathode for electrolytic coating.

20. The process as claimed in claim 16, wherein
the process proceeds continuously,
the CNT yarns required to form the strand-like material composite are provided simultaneously, and
as the process sequence continues, the CNT yarns are guided in parallel, are together enveloped with the metallic component and are joined together to form the yarns of larger diameter until the required cross-sectional area is achieved.

21. The process as claimed in claim 16, wherein
the CNT yarns and/or the larger diameter yarn are joined together by stranding.

22. The process as claimed in claim 16, wherein
the volumetric proportion of CNT yarns in the strand-like material composite is set by varying the duration of each enveloping process.

23. The process as claimed in claim 16, wherein
the CNT yarns occupy 4 to 10% by volume of the strand-like material composite.

24. The process as claimed in claim 17, wherein
the CNT yarns and/or the larger diameter yarn are enveloped with the metallic component using an electrochemical coating process.

25. The process as claimed in claim 24, wherein
the CNT yarns and/or the larger diameter yarn are coated electrolytically with the metallic component, and
the CNT yarns and/or the larger diameter yarn are connected as a cathode for electrolytic coating.

26. The process as claimed in claim 25, wherein
the process proceeds continuously,
the CNT yarns required to form the strand-like material composite are provided simultaneously, and
as the process sequence continues, the CNT yarns are guided in parallel, are together enveloped with the metallic component and are joined together to form the yarns of larger diameter until the required cross-sectional area is achieved.

27. The process as claimed in claim 26, wherein
the CNT yarns and/or the larger diameter yarn are joined together by stranding.

28. The process as claimed in claim 27, wherein
the volumetric proportion of CNT yarns in the strand-like material composite is set by varying the duration of each enveloping process.
